(19) United States
(12) Patent Application Publication
(10) Pub. No.: US 2025/0033618 A1
(43) Pub. Date: Jan. 30, 2025

(54) EXTERNALLY ADJUSTABLE PRESSURE MODULATING VALVE

(71) Applicant: ZF Off-Highway Solutions Minnesota Inc., North Mankato, MN (US)

(72) Inventors: Michael Prahl, Garden City, MN (US); Peter Backes, North Mankato, MN (US)

(73) Assignee: ZF Off-Highway Solutions Minnesota Inc., North Mankato, MN (US)

(21) Appl. No.: 18/357,706

(22) Filed: Jul. 24, 2023

(51) Int. Cl. B60T 11/28; B60T 1/093; F16K 1/30

(52) U.S. Cl. CPC B60T 11/28; B60T 1/093; F16K 1/302

(57) ABSTRACT

An externally adjustable pressure modulating valve is disclosed. In one example, the valve has a valve body extending along a valve axis and defining a plunger cavity extending axially into a first end of the valve body. A valve spool is retained in the valve body and is movable along the valve axis. An input plunger is slidable axially in the plunger cavity between a resting position and an actuated position. An external adjustment mechanism is configured to adjust the modulation spring force when the input plunger is fully actuated. In one example, the adjustment mechanism includes a threaded sleeve in the plunger cavity, where rotating the threaded sleeve changes the mechanical stop of the input plunger.

### TECHNICAL FIELD

The present disclosure relates generally to hydraulic braking systems and more particularly to an externally adjustable pressure modulating valve.

### BACKGROUND

A pressure modulating valve (“PMV”) is a type of valve that provides a constant inlet or outlet pressure. A PMV can be part of a hydraulic braking system where it is useful to control the brake output pressure. The output pressure of the valve at full actuation can be set by using a shim pack under the modulation springs. For example, one or more shims are placed between the modulation springs and the valve body to adjust the compression of the springs and therefore the spring load on the input plunger. The output pressure can be adjusted by installing, changing, or removing the shim pack, such as adding a shim pack with a greater thickness to increase the modulation spring force.

### SUMMARY

The present disclosure is directed to an externally adjustable modulating valve, such as for use with hydraulic brake assemblies. In one embodiment, the modulating valve is configured as a full-power pressure modulating valve for use in off-highway equipment, such as industrial trucks, mining equipment, road construction equipment, and the like. Unlike the use of a shim pack to adjust the output pressure in a stepwise fashion, a modulating valve according to the present disclosure provides a continuous range of adjustment by changing the dimension of the spring cavity housing the modulation spring(s) and/or changing the position of the mechanical stop for the input plunger. In one example, the spring cavity is formed in part by a valve sleeve that is threadably coupled to the valve housing. Threading the valve sleeve into or out of the housing provides continuous adjustment to the dimension of the spring cavity, thus providing a continuous range of adjustment to the modulation spring force and therefore to the brake output pressure when the input plunger is fully stroked. In other embodiments, the dimension of the spring cavity can be similarly adjusted by a threaded end cap received in the end of the input plunger, or a two-part housing with a threaded junction adjacent the interface between the valve ball and the valve spool. All of these approaches modulate output pressure by adjusting the modulation spring force.

Advantageously, external adjustment allows for a smaller tolerance of the set pressure, in contrast to stepwise adjustment attained with shims. Also, external adjustment of the modulation spring force eliminates the need to disassemble the valve as is required for shim packs. For example, after final assembly of the pressure modulating valve, the adjusting sleeve can be rotated until achieving the desired output pressure. The pressure can be set in one application of the valve and no disassembly of the valve is needed. In some embodiments, after setting the modulation spring force, the spring cavity can be fixed by advancing one or more set screws to bind the threads or otherwise restrict or prevent movement of the threaded components.

A pressure modulating valve as variously disclosed herein can be provided as a stand-alone part or as part of a brake assembly.

The present disclosure is also directed to a method for setting a valve output pressure, which can be automated. An automated system can be implemented, for example, to eliminate the need for an experienced and skilled technician. For example, an assembled valve can be tested and adjusted to specification using an automated system that supplies an input pressure line and determines the output pressure. In one embodiment, the method includes providing a valve having continuous adjustment to the modulation spring cavity. The system delivers supply pressure to the valve's pressure port and the system determines the output pressure at full stroke of the input plunger. If the output pressure is not within a predefined range, the system rotates the sleeve or other adjustable component of the valve, such as using a collet that engages the sleeve, until the output pressure is at the desired value.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the disclosed subject matter.

### BRIEF DESCRIPTION OF THE DRAWINGS

FIG. 1 illustrates a cross-sectional view of a pressure modulating valve that utilizes shims, in accordance with the prior art.

FIG. 2A illustrates an elevational view of a pressure modulating valve, in accordance with an embodiment of the present disclosure.

FIG. 2B illustrates a top and cross-sectional view of an externally adjustable pressure modulating valve as viewed along line B-B of FIG. 2A, in accordance with an embodiment of the present disclosure.

FIG. 2C illustrates an elevational and cross-sectional view of an externally adjustable pressure modulating valve as viewed along line A-A of FIG. 2A, in accordance with an embodiment of the present disclosure.

FIG. 3 illustrates a brake pedal assembly incorporating a pressure modulating valve, in accordance with an embodiment of the present disclosure.

FIG. 4 illustrates a method of setting a pressure modulating valve, in accordance with an embodiment of the present disclosure.

FIG. 5 illustrates a cross-sectional view showing an upper portion of a pressure modulating valve having a two-part input plunger, in accordance with another embodiment of the present disclosure.

FIG. 6 illustrates a cross-sectional view showing an upper portion of a pressure modulating valve having a two-part valve body, in accordance with another embodiment of the present disclosure.

The figures depict various embodiments of the present disclosure for purposes of illustration only. Numerous variations, configurations, and other embodiments will be apparent from the following detailed discussion.

### DETAILED DESCRIPTION

An externally adjustable pressure modulating valve is disclosed. In one example, the valve has a valve body extending along a valve axis and defining a plunger cavity extending axially into a first end of the valve body. A valve spool is retained in the valve body and is movable along the valve axis. The valve has an adjustment mechanism configured for external adjustment of the modulation spring force at full stroke. In one embodiment, the adjustment mechanism includes a threaded sleeve that is received in the plunger cavity of the valve body, the threaded sleeve being rotatable to adjust an axial dimension of the plunger cavity and/or adjust an axial position of the mechanical stop for the input plunger. An input plunger is slidable axially in the plunger cavity between a resting position and an actuated position. One or more modulation springs are housed between the input plunger and a spring retainer adjacent the valve spool.

In another embodiment, the external adjustment can be accomplished by a two-piece housing, where rotating the first housing part relative to a second housing part changes the axial dimension of the plunger cavity. In yet other embodiment, the valve has a two-part input plunger that is adjustable to change the axial dimension of the modulation spring cavity, at least part of which is defined by a hollow region inside the input plunger. For example, the input plunger has a threaded cap or insert that can be rotated to adjust the compression of the modulating spring(s) when the input plunger is fully actuated.

A method of setting a pressure modulating valve is also disclosed. In one embodiment, the method includes providing an externally adjustable pressure modulating valve, determining an output pressure at a given supply pressure when the input plunger is fully actuated, and adjusting an axial position of the mechanical stop and/or axial dimension of the modulation spring cavity to adjust the modulation spring force. The method may also include fixing the adjustment mechanism, such as by advancing a set screw, tightening a locking ring, or using a thread locking composition. Optionally, a label can be affixed to the valve body to identify the valve model, the serial number, and/or the pressure setting. Optionally, the position of an actuating surface of the input plunger can be adjusted axially to optimize engagement with an actuator, such as a brake pedal.

### Overview

Existing pressure modulating valves use a shim pack under the modulation spring(s) to set the output pressure of the valve. To make changes to the output pressure by altering the shim(s), one must have access to the input plunger, springs, and spring retainer. After the shims are adjusted to bring the pressure into the specified range, the valve components must be reassembled and tested. This adjustment cycle repeats, typically two to three times, until the output pressure is within the specified range or until the technician fails the entire valve and sends the valve to be reworked or scrapped.

The existing process of adjusting the shims is time consuming and typically requires a highly trained and skilled technician. In addition, output pressure is adjusted in increments as dictated by the thickness of each shim. Thus, it would be desirable to simplify adjustment to the output pressure of a pressure modulating valve. It would also be desirable to be able to adjust the output pressure along a continuous range of values rather than stepped increments. Further, it would be desirable to be able to adjust the output pressure without disassembling the valve.

The present disclosure addresses these needs and others by providing an externally adjustable pressure modulating valve. In one example embodiment, the shim pack can be eliminated and replaced with an adjustment mechanism movable to change the internal, mechanical stop of the input plunger and/or to alter the axial dimension of the modulation spring cavity. For example, the adjustment mechanism includes a threaded sleeve that is received in the plunger cavity, where rotating the sleeve changes the position of the mechanical stop for the input plunger.

In some embodiments, a threaded adjusting button at the top of the input plunger is adjustable to control the height of the fully applied pressure modulating valve, in contrast to existing designs where the height is controlled by the internal mechanical stop of the input plunger. In one example, the adjusting button is configured as a threaded cap that is received in the exposed end of the input plunger, where rotating the adjusting button changes the axial position of an actuating surface.

As used herein, terms referencing direction, such as upward, downward, top, bottom, etc., are used for convenience to describe components of a valve oriented along a vertical valve axis, where an actuating surface is at the top of the valve. Embodiments of the present disclosure are not limited by these directional terms and it is contemplated that a valve according to the present disclosure can be used in any orientation.

### Example Embodiments

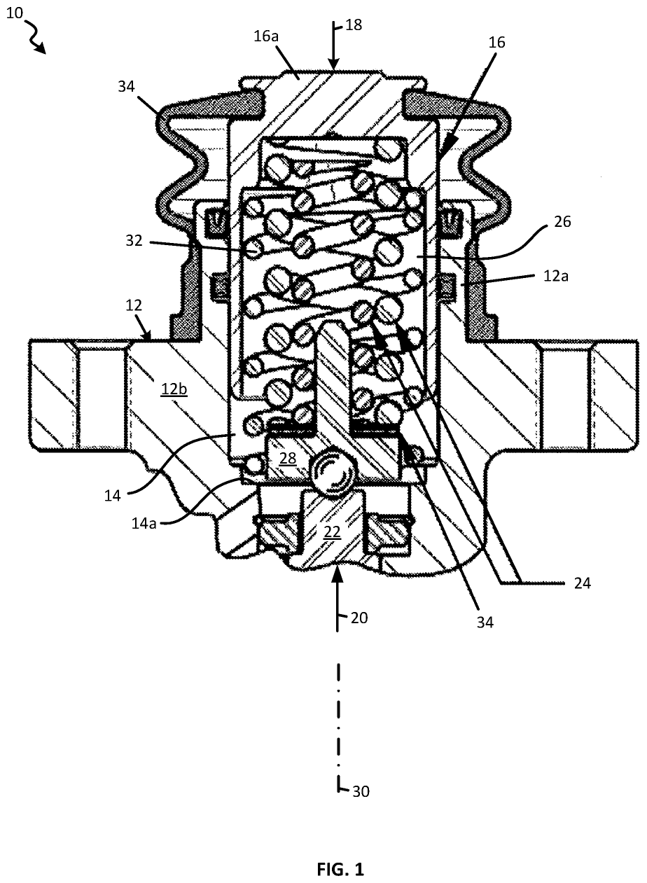

FIG. 1 illustrates a cross-sectional view of a pressure modulating valve 10, or simply “valve 10,” in accordance with an embodiment of the present disclosure. The valve 10 is configured as a spool valve and includes a valve body 12 defining a plunger cavity 14. In this example, the valve body 12 includes a cylindrical wall 12a that is formed monolithically with and extends upward from the valve body 12 to define part of the plunger cavity 14. In more detail, part of the plunger cavity 14 is defined in the flange portion 12b of the valve body 12 and part of the plunger cavity 14 is defined in the cylindrical wall 12a extending axially away from the flange portion 12b. As will be appreciated, the flange portion 12b can be referred to as a mounting flange or mounting surface. In other embodiments, the plunger cavity 14 is defined in the valve body below the flange portion 12b rather than protruding above the flange portion 12b.

An input plunger 16 is movably received in the plunger cavity 14 and can move axially along a valve axis 30 in response to an actuating force 18 acting on a first end 16a of the input plunger 16, a return force 20 acting in an opposite direction on a valve spool 22, and/or a force of one or more modulation springs 24. As the input plunger 16 moves, a flexible boot 34 compresses or expands axially so as to prevent intrusion of dust and the like during operation. In this example, the input plunger 16 defines part of a spring cavity 26 that extends through an open second end 16b of the input plunger 16 to the plunger cavity 14. One or more modulation springs 24 are retained in the spring cavity 26 between the first end 16a of the input plunger and a retainer 28 at a base 14a of the plunger cavity 14. A plunger return spring 32 is retained between the input plunger 16 and the valve body 12 and biases the input plunger 16 axially away from the spool 22 toward a resting position (e.g., upward as shown in FIG. 1). In some embodiments, the input plunger 16 is retained in the valve by a collar (not shown).

In accordance with known methodologies, a shim pack 34 is positioned between the modulation spring(s) 24 and the spring retainer 28. The shim pack 34 has an axial thickness that is selected to provide a desired compression of the modulation spring(s) 24 in the fully applied or fully actuated state. The shim pack 34 can be selected to have a greater or lesser thickness to step up or step down the spring force of the modulation spring(s) 24 so that the output pressure is within a desired range for a given input pressure when the input plunger is fully actuated.

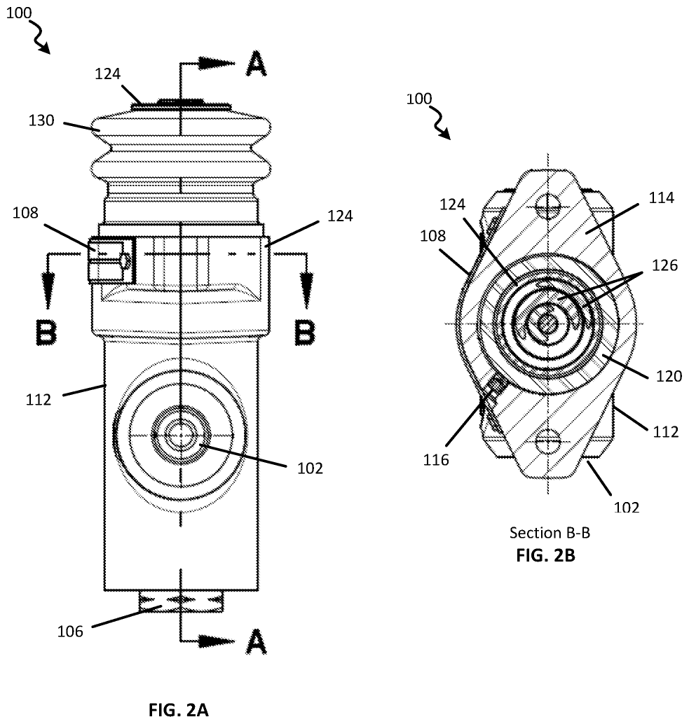

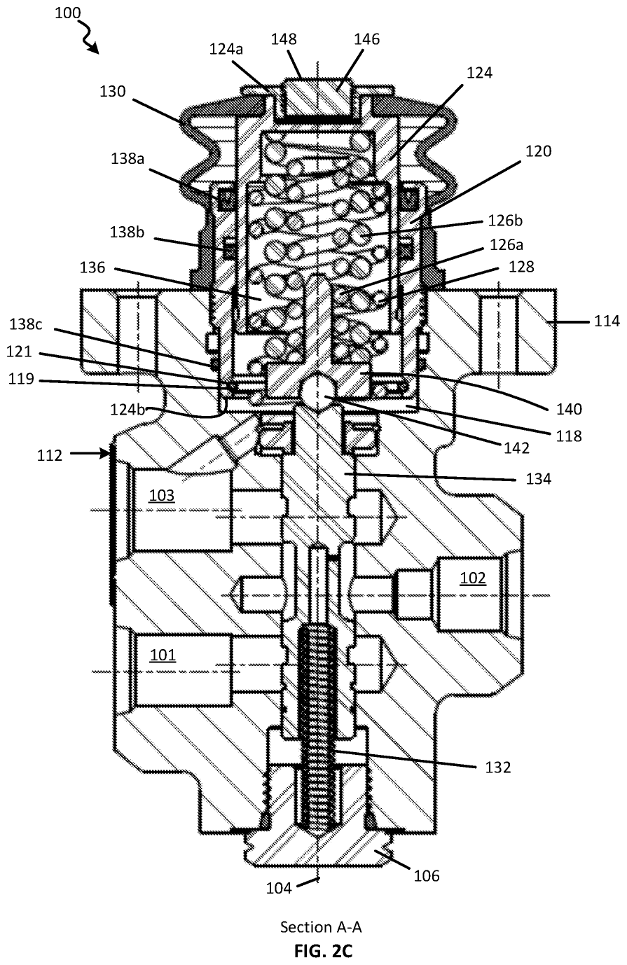

FIG. 2A illustrates an elevational view looking at a brake port 102 of a pressure modulating valve 100 (or simply “valve 100”), in accordance with another embodiment of the present disclosure. Part of an end plug 106 is visible protruding from the bottom of the valve body 112. The end plug 106 is threadably received in the valve body 112 and retains the valve spool 134 (not visible; shown in FIG. 2C). A first or upper end 124a of the input plunger 124 can be seen protruding from a flexible boot 130. In some embodiments, the valve 100 includes an affixed label 108 identifying the valve model, serial number, or output pressure setting at the brake port 102 for a given supply pressure provided to the pressure port 101. After setting the output pressure, for example, the label 108 can be affixed to the valve body 112.

FIG. 2B illustrates a top view of section B-B taken through the flange portion 114. Label 108 can be seen affixed to the valve body 112 along one side of the flange portion 114. Also visible in section B-B is a set screw 116 that extends through the flange portion 114 to engage an adjustable sleeve 120. An input plunger 124 is radially inside of the sleeve 120 and modulation springs 126 are radially inside of the input plunger 124. The set screw 116 is an example of a locking structure that can be used to lock the position of the sleeve 120. Other suitable locking structures include a jam nut on the threaded sleeve or a thread locking compound applied to the threads, for example.

FIG. 2C illustrates an elevational view showing section A-A of valve 100 of FIG. 2A-2B. In this example, the valve body 112 defines a pressure port 101, a brake port 102, and a tank port 103. The valve 100 is configured as a spool valve and therefore has a valve spool 134 retained in the valve body 112 by end plug 106, where the valve spool 134 is movable along a valve axis 104. A spool return spring 132 biases the valve spool 134 towards a first position or resting position, which is shown as an upward position in this example.

In this embodiment, valve 100 has a sleeve 120 that is threadably received in the valve body 112. The sleeve 120 extends or protrudes from the flange portion 114 of the valve body 112 along the valve axis 104 to define the plunger cavity 118. In more detail, the plunger cavity 118 is defined in part by the valve body 112 and in part by the sleeve 120.

An input plunger 124 is slidably received in the plunger cavity 118 and can move axially along a valve axis 104 in response to an actuating force acting on a first end 124a of the input plunger 124, a pressure and/or spring force acting in an opposite direction on the valve spool 134, and/or a force of one or modulation spring(s) 126. As noted above, the sleeve 120 need not extend beyond the flange portion 114 such that the input plunger is recessed within or protrudes only slightly from the valve body 112 when at rest. In other embodiments, for example, the sleeve 120 is received in a plunger cavity 118 that extends axially into the valve body 112 to a sufficient depth that the input plunger 124 does not protrude from the valve body 112 (e.g., from the flange portion 114). In one such example, the input plunger 124 can be retained in the valve body 112 with a threaded annular ring.

The sleeve 120 defines a mechanical stop for the input plunger adjacent the spring retainer 140. In this example, the mechanical stop is or includes a retaining ring 119 formed with round wire that is recessed into a circumferential groove 121 on the inside of the sleeve 120. Other mechanical stops can be used, including a ledge, protrusion, or annular wall on the inside of the sleeve 120, for example. Due to the threaded engagement with the valve body 112, the sleeve 120 is adjustable, where rotating the sleeve 120 changes the axial position of the sleeve 120 and thus changes the axial position of the mechanical stop the retaining ring 119 in this example. Adjusting the mechanical stop in turn changes the spring force of the modulation spring(s) 126 when the input plunger 124 is fully actuated (e.g., actuated to contact with the mechanical stop). As shown in this example, the modulation spring cavity 136 is defined in part by a hollow region inside the input plunger 124 and in part by the sleeve 120. Thus, adjusting the position of the sleeve 120 also adjusts the modulation spring force at full stroke of the input plunger 124.

In this example, the input plunger 124 defines part of the modulation spring cavity 136 that extends through an open second end 124b (e.g., bottom end) of the input plunger 124 to the plunger cavity 118. One or more modulation springs 126 are retained in the modulation spring cavity 136 between the first end 124a (e.g., top end) of the input plunger 124 and a spring retainer 140. In this example, valve 100 includes an inner modulation spring 126a and an outer modulation spring 126b. In other embodiments, a single modulation spring 126 is acceptable. A plunger return spring 128 is retained between the first end 124a of the input plunger 124 and the valve body 112 and biases the input plunger 124 axially away from the valve spool 134 to the resting position (e.g., upward as shown in FIG. 2C). The spring retainer 140 interfaces with the valve spool 134 at a ball seat 142. In some embodiments, the modulation spring(s) 126 attain the free length of the spring in the resting position.

A flexible boot 130 is around the portion of the sleeve 120 that protrudes from the valve body 112 (e.g., upper portion of sleeve 120). The boot 130 forms a water-tight seal with the input plunger 124 and with the sleeve 120 to keep out dust, moisture, and particulates. Valve 100 can include one or more seals 138. In this example, valve 100 has a first seal 138a adjacent a top end of the sleeve 113. The first seal 138a can be a wiper-type seal or cup seal configured to prevent intrusion of dust and other particles, in some embodiments. A second seal 138b is between the sleeve 120 and the input plunger 124, such as between the top end of the sleeve 120 and the flange portion 114 of the valve body 112. The second seal 138b can be an O-ring type seal, for example. In embodiments having the flexible boot 130, the second seal 138b may be considered redundant and/or optional. A third seal 138c, such as an O-ring seal, is between valve body 112 and sleeve 120 to prevent oil leakage.

The sleeve 120 is illustrated as being cylindrical and having a smooth outer surface, where rotating the sleeve 120 can be accomplished, for example, by engagement with a collet or the like. In other embodiments, the outside of the sleeve 120 can define wrench flats or some other suitable feature that would enable rotating the sleeve using a wrench or other tool. Numerous variations and embodiments will be apparent in light of the present disclosure.

In some embodiments, valve 100 includes an adjusting button 146 at the first end 124a of the input plunger 124. For example, the adjusting button 146 is threadably received in the first end 124a of the input plunger 124 and is rotatable to adjust the axial position of the actuating surface 148. In use, the adjusting button 146 can be adjusted for optimal engagement with an actuator, such as a brake pedal. In some embodiments, the adjusting button 146 defines wrench flats for rotation by a wrench; however, wrench flats are not required. In other embodiments, the adjusting button 146 and actuating surface 148 are not required for proper operation of the valve 100, and therefore are optional. In some embodiments, the input plunger 124 can have a solid, one-piece structure, where modulation spring(s) 126 are between the input plunger 124 and the spring retainer 140.

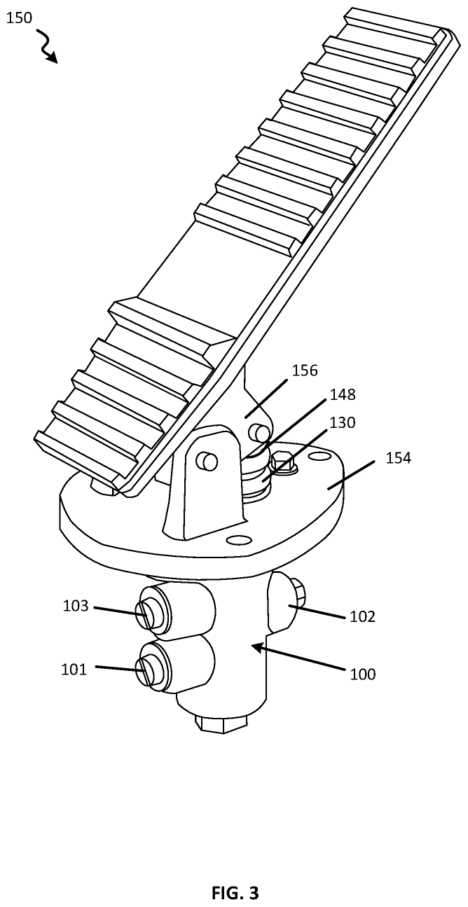

Referring now to FIG. 3, a perspective view illustrates a brake valve assembly 150, in accordance with an embodiment of the present disclosure. In this example, the brake valve assembly 150 includes a brake pedal 152 pivotably mounted to a base 154 of plate-like geometry. Brake valve 100 is mounted to the base 154 with the input plunger 124 extending through the base 154 so that the actuating surface 148 engages the brake actuator 156. In some embodiments, the brake actuator 156 includes a roller 148 arranged to interface with the actuating surface 148 on the input plunger 124. In other embodiments, the brake actuator 156 is coupled to the input plunger 124 using a pin or other fastener, for example.

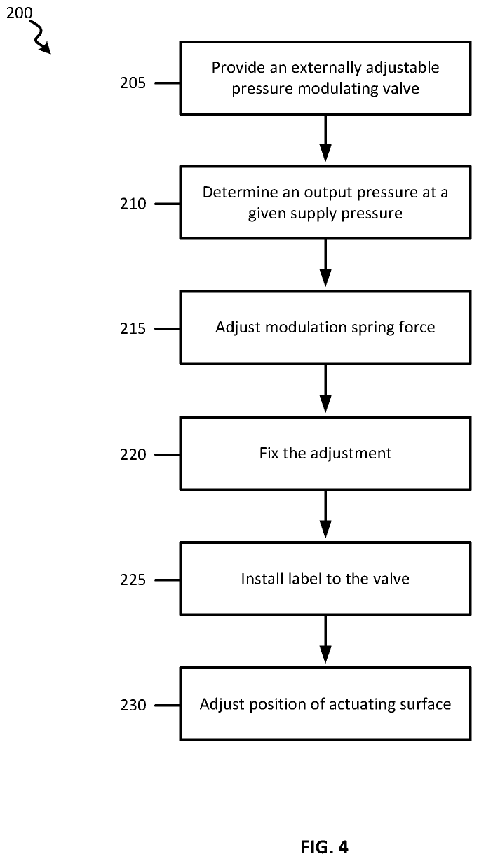

FIG. 4 illustrates steps in a method 200 of adjusting a pressure modulating valve, in accordance with an embodiment of the present disclosure. Method 200 is discussed with reference to a pressure modulating brake valve, but method 200 is not limited to brake valves and can be applied generally to valves utilizing pressure modulation.

Method 200 begins with providing 205 a pressure modulating valve having an externally adjustable modulation spring force. In some embodiments, the valve includes an adjustable sleeve that is threadably received in the valve body, where rotation of the sleeve changes the position of the mechanical stop for the input plunger and therefore the modulation spring force at full stroke of the input plunger. Adjusting the sleeve may also or alternately change the axial dimension of the modulation spring cavity, therefore changing the modulation spring force at full stroke of the input plunger. One such embodiment is brake valve 100 discussed above.

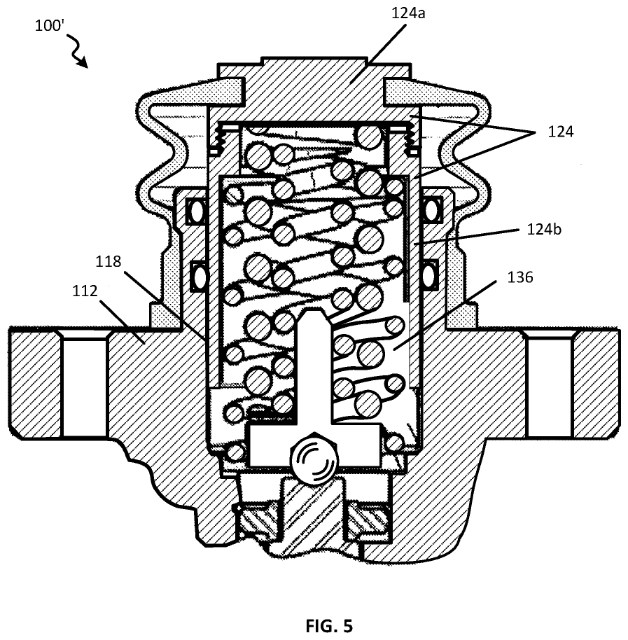

In other embodiments, the valve has a two-piece input plunger, such as a plunger having a threaded end cap or insert that is received in or on the body of the input plunger, where rotation of the end cap changes the dimension of the modulation spring cavity, which is defined in part by a hollow region within the input plunger. One such embodiment is shown, for example, in FIG. 5. In this example, valve 100′ has a valve body 112 defining a plunger cavity 118. The input plunger 124 has a cap 124a that is threadably attached to the plunger body 124b. The cap 124a can be rotated to adjust the axial dimension of the modulation spring cavity 136.

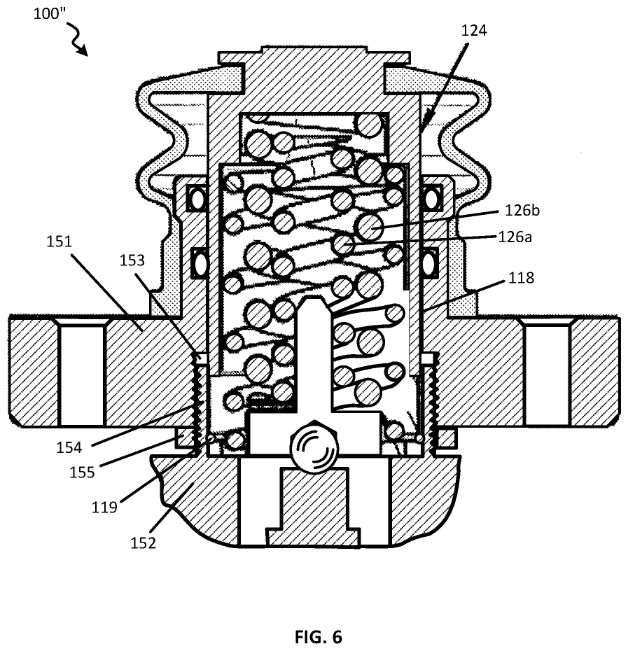

In yet other embodiments, the valve has a two-piece valve body. For example, the valve is divided into a first or lower portion and a second or upper portion, where the upper portion defines a plunger cavity. The lower portion includes a threaded sleeve that is received in a threaded recess in the bottom of the upper portion, where the lower valve portion defines the bottom or base of the plunger cavity. By rotating the lower valve portion with respect to the upper valve portion, the threaded sleeve is advanced into or withdrawn from the upper valve portion, thereby changing the position of the mechanical stop and/or the axial dimension of the plunger cavity. One such valve 100″ is shown in FIG. 6. Valve 100″ includes an upper valve portion 151 and a lower valve portion 152, where the lower valve portion 152 is threadably received in a recess 153 defined in the upper valve portion 151, or vice versa. In this example, the lower valve portion 152 includes a threaded, cylindrical wall 154 that threadably engages the recess 153, which is also threaded. A locking nut 155 on the cylindrical wall 154 between the valve portions 151, 152 can be tightened to fix the axial spacing of the valve portions 151, 152. Changing the axial spacing of the valve portions 151, 152 changes the spring force of modulation springs 126a, 126b. Similar to valve 100 discussed above, the input plunger 124 is received in the plunger cavity 118, which is defined between the upper and lower valve portions 151, 152. A retaining ring 119 is recessed into the inside of the cylindrical wall 154 and functions as a mechanical stop for the input plunger 124. Other mechanical stops can be used, as will be appreciated.

Method 200 continues with determining 210 an output pressure at full stroke of the input plunger for a given supply pressure. If the output pressure is within the desired range, no adjustment is necessary. If the output pressure is outside of the desired range, then method 200 continues with adjusting 215 the modulation spring force at full stroke of the input plunger via an external adjustment mechanism. In the case of valve 100 having an adjustable sleeve, for example, the adjustment mechanism is a threaded sleeve that can be rotated into or out of the valve body to change the mechanical stop of the input plunger and/or the axial dimension of the modulation spring cavity. For example, a collet engages the sleeve and rotates the sleeve to adjust the modulation spring pressure at full stroke. In the case of a two-piece input plunger, the threaded cap can be rotated to increase or reduce the axial dimension of the modulation spring cavity. In the case of a two-piece valve body, the first valve portion can be rotated with respect to the second valve portion, thereby changing the axial dimension of the modulation spring cavity.

Method 200 continues with fixing 220 the modulation spring force. In some embodiments, step 220 can be performed by fixing the position of the mechanical stop or fixing the dimension of the modulation spring cavity. In the case of valve 100, a set screw can be advanced to engage the adjustable threaded sleeve. As noted above, other methods can be used to fix the sleeve position, including a locking ring, jam nut, or thread locking compound. Doing so inhibits or prevents inadvertent rotation of the sleeve, thereby fixing the position of the mechanical stop and the dimension of the modulation spring cavity at full stroke. In the case of a two-piece input plunger, a locking ring or jam nut on the threaded cap can be tightened against the top of the input plunger. Alternately, a set screw can be advanced to engage the threads or bind the threads to prevent inadvertent movement of the threaded components. In the case of the two-part valve body, a locking nut around the threaded sleeve can be tightened against the upper valve portion. Other methods of inhibiting rotation of threaded components are acceptable as will be appreciated in light of the present disclosure.

Method 200 optionally continues with installing 225 a label on the valve to indicate the output pressure setting, part number, and/or serial number, for example. In one example, the label is a metal label affixed to the flange portion of the valve body. The label can be affixed using fasteners, welding, or other suitable method. In some embodiments, the label is installed to cover access to the set screw so as to prevent changing the valve setting or to provide evidence of tampering with the valve setting.

Method 200 optionally continues with adjusting 230 the position of the actuating surface on the input plunger. In some embodiments, for example, providing 205 the externally adjustable pressure modulating valve includes selecting the valve to include an adjusting button that includes an actuating surface, connector, or coupling. For example, the adjusting button is threadably received in the top of the input plunger, where rotating the adjusting button changes the axial position of the actuating surface for engaging an actuator of a brake pedal.

Note that the steps of method 200 are shown and described in a particular order for ease of description. However, one or more of the steps may be performed in a different order or may not be performed at all (and thus be optional), in accordance with some embodiments. Numerous variations on method 200 and the techniques described herein will be apparent in light of this disclosure.

### FURTHER EXAMPLE EMBODIMENTS

The following examples pertain to further embodiments, from which numerous permutations and configurations will be apparent.

Example 1 is an externally adjustable pressure modulating valve, comprising a valve body extending along a valve axis and defining a pressure port, an output port, a tank port, and a plunger cavity. A valve spool is retained in the valve body and movable along the valve axis. An input plunger in the plunger cavity is movable along the valve axis between a resting position and a fully actuated position. One or more modulation springs are between the input plunger and the valve spool. An adjustment mechanism is operable from an outside of the valve to change a force of the one or more modulation springs when the input plunger is in the fully actuated position.

Example 2 includes the pressure modulating valve of Example 1, where the adjustment mechanism comprises a threaded sleeve in the plunger cavity, and where rotation of the threaded sleeve changes a mechanical stop of the input plunger.

Example 3 includes the pressure modulating valve of Example 2, where the threaded sleeve defines the mechanical stop for the input plunger.

Example 4 includes the pressure modulating valve of Example 3, where the mechanical stop comprises a retaining ring received in a circumferential recess on an inside of the threaded sleeve.

Example 5 includes the pressure modulating valve of any one of Examples 1-4 and further comprises a locking structure operable to fix a position of the threaded sleeve.

Example 6 includes the pressure modulating valve of Example 5, where the locking structure comprises one or more of a set screw and a locking nut.

Example 7 includes the pressure modulating valve of any one of Examples 1-6, where the adjustment mechanism is operable to adjust an axial dimension of the modulation spring cavity.

Example 8 includes the pressure modulating valve of Example 7, where the modulation spring cavity is defined at least in part by a hollow region in the input plunger and wherein the adjustment mechanism comprises a threaded cap on the input plunger, the threaded cap rotatable to change the axial dimension of the modulation spring cavity.

Example 9 includes the pressure modulating valve of Example 1, wherein the valve body comprises a first valve portion and a second valve portion, the first valve portion having a threaded sleeve received in a threaded recess in the second valve portion, wherein rotating the first valve portion with respect to the second valve portion changes an axial dimension of the modulation spring cavity.

Example 10 includes the pressure modulating valve of Example 9 and further comprises a locking nut on the threaded sleeve between the first valve portion and the second valve portion.

Example 11 includes the pressure modulating valve of any one of Examples 1-10 and further comprises an axially adjustable actuation surface on the input plunger.

Example 12 includes the pressure modulating valve of Example 11, where the axially adjustable engagement surface comprises a threaded cap on an end of the input plunger.

Example 13 includes the pressure modulating valve of any one of Examples 1-12, where the one or more modulation springs includes an inner modulation spring and an outer modulation spring.

Example 14 includes the pressure modulating valve of any one of Examples 1-13 and further comprises a plunger return spring configured and arranged to bias the input plunger toward the resting position.

Example 15 is a brake pedal assembly, comprising a base plate, an externally adjustable pressure modulating valve according to any of Examples 1-14, where the externally adjustable pressure modulating valve is mounted to the base plate, and a brake pedal pivotably mounted to the base plate and having an actuator configured and arranged to actuate the input plunger of the pressure modulating valve.

Example 16 is a method of adjusting a pressure modulating valve, comprising providing a pressure modulating valve having an input plunger, the pressure modulating valve configured to be externally adjustable to adjust a spring force of a modulation spring when the input plunger is fully actuated; determining an output pressure at a given supply pressure when the input plunger is fully actuated; and adjusting an axial position of the mechanical stop and/or an axial dimension of a modulation spring cavity.

Example 17 includes the method of Example 16, where adjusting the axial position of the mechanical stop and/or the axial dimension of the modulation spring cavity includes rotating a threaded sleeve in the valve body, wherein the input plunger is at least partially received in the threaded sleeve.

Example 18 includes the method of Example 16 or 17 and further comprises fixing the modulation spring force.

Example 19 includes the method of Example 18, where fixing the modulation spring force is performed at least in part by advancing a set screw.

Example 20 includes the method of Example 18 or 19, where fixing the modulation spring force is performed at least in part by tightening a locking nut.

Example 21 includes the method of any one of Examples 18-20, where fixing the modulation spring force includes applying a thread-locking compound to threads of the adjustment mechanism of the valve.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

What is claimed is:

1. An externally adjustable pressure modulating valve, comprising:
a valve body extending along a valve axis and defining a pressure port, an output port, a tank port, and a plunger cavity;
a valve spool retained in the valve body and movable along the valve axis;
an input plunger in the plunger cavity and movable along the valve axis between a resting position and a fully actuated position;
one or more modulation springs in a modulation spring cavity between the input plunger and the valve spool; and
an adjustment mechanism operable from an outside of the valve to change a force of the one or more modulation springs when the input plunger is in the fully actuated position.

2. The externally adjustable pressure modulating valve, of claim 1, wherein the adjustment mechanism comprises a threaded sleeve in the plunger cavity, wherein rotation of the threaded sleeve changes a mechanical stop of the input plunger.

3. The externally adjustable pressure modulating valve of claim 2, wherein the threaded sleeve defines the mechanical stop for the input plunger.

4. The externally adjustable pressure modulating valve of claim 3, wherein the mechanical stop comprises a retaining ring received in a circumferential recess on an inside of the threaded sleeve.

5. The externally adjustable pressure modulating valve of claim 2, further comprising a locking structure operable to fix a position of the threaded sleeve.

6. The externally adjustable pressure modulating valve of claim 5, wherein the locking structure comprises one or more of a set screw and a locking nut.

7. The externally adjustable pressure modulating valve of claim 1, wherein the adjustment mechanism is operable to adjust an axial dimension of the modulation spring cavity.

8. The externally adjustable pressure modulating valve of claim 7, wherein the modulation spring cavity is defined at least in part by a hollow region in the input plunger and wherein the adjustment mechanism comprises a threaded cap on the input plunger, the threaded cap rotatable to change the axial dimension of the modulation spring cavity.

9. The externally adjustable pressure modulating valve of claim 1, wherein the valve body comprises a first valve portion and a second valve portion, the first valve portion having a threaded sleeve received in a threaded recess in the second valve portion, wherein rotating the first valve portion with respect to the second valve portion changes an axial dimension of the modulation spring cavity.

10. The externally adjustable pressure modulating valve of claim 9, further comprising a locking nut on the threaded sleeve between the first valve portion and the second valve portion.

11. The externally adjustable pressure modulating valve of claim 1, further comprising an axially adjustable actuation surface on the input plunger.

12. The externally adjustable pressure modulating valve of claim 11, wherein the axially adjustable engagement surface comprises a threaded cap on an end of the input plunger.

13. The externally adjustable pressure modulating valve of claim 1, wherein the one or more modulation springs includes an inner modulation spring and an outer modulation spring.

14. The externally adjustable pressure modulating valve of claim 13, further comprising a plunger return spring configured and arranged to bias the input plunger toward the resting position.

15. A brake pedal assembly, comprising:
a base plate;
an externally adjustable pressure modulating valve according to claim 1, the externally adjustable pressure modulating valve mounted to the base plate; and
a brake pedal pivotably mounted to the base plate and having an actuator configured and arranged to actuate the input plunger of the pressure modulating valve.

16. The brake pedal assembly of claim 15, wherein the adjustment mechanism comprises a threaded sleeve in the plunger cavity, wherein rotation of the threaded sleeve changes a mechanical stop of the input plunger.

17. The brake pedal assembly of claim 15, wherein the adjustment mechanism is operable to adjust an axial dimension of the modulation spring cavity.

18. The brake pedal assembly of claim 16, further comprising an axially adjustable actuation surface on the input plunger.

19. A method of adjusting a pressure modulating valve, comprising:
providing a pressure modulating valve having an input plunger, the pressure modulating valve configured to be externally adjustable to adjust a spring force of a modulation spring when the input plunger is fully actuated;
determining an output pressure at a given supply pressure when the input plunger is fully actuated; and
adjusting an axial position of the mechanical stop and/or an axial dimension of a modulation spring cavity.

20. The method of claim 19, wherein adjusting the axial position of the mechanical stop and/or the axial dimension of the modulation spring cavity includes rotating a threaded sleeve in the valve body, wherein the input plunger is at least partially received in the threaded sleeve.
